(19) United States
(12) Patent Application Publication
(10) Pub. No.: US 2010/0083315 A1
(43) Pub. Date: Apr. 1, 2010

(54) SYSTEMS AND METHODS FOR GRAPHICAL CONTROL OF USER INTERFACE FEATURES PROVIDED BY A TELEVISION RECEIVER

(75) Inventors: James Matthew WHITE, Denver, CO (US); Karen Michelle TAXIER, Highlands Ranch, CO (US); Luke VANDUYN, Highlands Ranch, CO (US); Daniel L. RUDOLPH, Castle Rock, CO (US)

Correspondence Address: INGRASSIA FISHER & LORENZ, P.C. (EchoStar), 7010 E. COCHISE ROAD, SCOTTSDALE, AZ, 85253, US

(73) Assignee: ECHOSTAR TECHNOLOGIES LLC, Englewood, CO (US)

(21) Appl. No.: 12/241,556

(22) Filed: Sep. 30, 2008

(51) Int. Cl. H04N 5/445; H04N 7/173

(52) U.S. Cl. 725/40; 725/131

(57) ABSTRACT

Systems and methods provide for changing the presentation of a current channel to another channel on a display in response to a viewer input received via a remote control. Viewer input from a remote control is received at a set-top box (STB) or similar television receiver. Imagery on the display initially corresponds to the current channel. At least a portion of the imagery is scrolled in response to the viewer input to thereby tune the other channel on the display.

### TECHNICAL FIELD

The present invention generally relates to user interfaces in television receiver devices, and more particularly relates to systems and methods for providing graphical scrolling of guide data, video and/or other features provided by a television receiver device.

### BACKGROUND

Most television viewers now receive their television signals through a content aggregator such as a cable or satellite television provider. For subscribers to a direct broadcast satellite (DBS) service, for example, television programming is received via a broadcast that is sent via a satellite to an antenna that is generally located on the exterior of a home or other structure. Other customers receive television programming through conventional television broadcasts, or through cable, wireless or other media. Programming is typically received at a receiver such as a “set top box” (STB) or other receiver that demodulates the received signals and converts the demodulated content into a format that can be presented to the viewer on a television or other display. In addition to receiving and demodulating television programming, many television receivers are able to provide additional features. Examples of features available in many modern television receivers include electronic program guides (EPGs), digital or other personal video recorders, “place-shifting” features for streaming received content over a network or other medium, providing customer service information and/or the like.

Generally speaking, viewers interact with the STB or other receiver using some sort of user interface that receives inputs from a remote control or other input device. To change a channel, for example, the viewer typically depresses a “channel up/down” button, manually enters a number of a desired channel on a numeric keypad, and/or selects the new channel using a program guide feature of the receiver. The receiver then processes received viewer input to make desired changes to the on-screen display.

While conventional interfaces are useful for many purposes, there remains a continual desire for more efficient and intuitive user interfaces to the various features provided by the receiver. It is therefore desirable to create systems and methods for improving the viewer interface to the television receiver. These and other desirable features and characteristics will become apparent from the subsequent detailed description and the appended claims, taken in conjunction with the accompanying drawings and this background section.

### BRIEF SUMMARY

According to various exemplary embodiments, systems and methods are provided for changing a channel or other information presented on a television or other display by a set-top box (STB) or other video receiver.

In various embodiments, a method is provided for changing the presentation of a current channel to another channel on a display in response to a viewer input received via a remote control. Viewer input from a remote control is received at a set-top box (STB) or similar television receiver. Imagery on the display initially corresponds to the current channel. At least a portion of the imagery is scrolled in response to the viewer input to thereby tune the other channel on the display.

In other embodiments, a video receiver is provided for presenting imagery on a display in response to viewer input signals provided from a remote control. The receiver suitably comprises a receiver interface configured to receive an incoming modulated signal and a decoder configured to decode the incoming modulated signal to extract a video signal. The receiver further comprises a wireless receiver configured to receive the viewer input signals from the remote control, and a processor configured to generate the imagery presented on the display. The imagery suitably comprises the extracted video signal, and the processor is further configured to change a channel associated with the video signal to a desired channel in response to the viewer input signals by generating a program guide window on the display that initially comprises program guide information corresponding to a current channel. The program guide information scrolls in the program guide window in response to the viewer input to display other program guide information until the desired channel is indicated by the displayed subsequent program guide information.

Still other embodiments provide a system for presenting television content on a display. The system suitably comprises a wireless remote control configured to provide an input signal in response to a user input, and a video receiver. The video receiver suitably comprises a receiver interface configured to receive an incoming modulated signal, a decoder configured to decode the incoming modulated signal to extract television content, a wireless receiver configured to receive the two-dimensional input signal from the wireless remote control, and a processor. The processor is configured to generate imagery to be presented on the display, wherein the imagery comprises the extracted television content, and wherein the processor is further configured to allow the viewer to change a channel associated with the television content to a desired channel in response by generating a program guide window that initially comprises program guide information corresponding to a current channel, and wherein the program guide information gradually scrolls in the program guide window in response to the viewer input to display other program guide information until the desired channel is indicated by the displayed subsequent program guide information.

Various other embodiments, aspects and other features are described in more detail below.

### BRIEF DESCRIPTION OF THE DRAWING FIGURES

Exemplary embodiments will hereinafter be described in conjunction with the following drawing figures, wherein like numerals denote like elements, and

FIG. 1 is a block diagram of an exemplary television receiver system;

FIG. 2 is a block diagram of an exemplary television receiver device;

FIGS. 3-5 are diagrams of exemplary screen displays; and

FIG. 6 is a flowchart showing an exemplary process for changing a channel with a television receiver.

### DETAILED DESCRIPTION

The following detailed description of the invention is merely exemplary in nature and is not intended to limit the invention or the application and uses of the invention. Furthermore, there is no intention to be bound by any theory presented in the preceding background or the following detailed description.

Generally speaking, the channel changing interface is improved by allowing smooth scrolling of programming and/or guide data in response to user inputs. When a viewer requests a channel change, the display presents a program guide window with program guide information about the current channel. The viewer is able to scroll the program guide information (e.g., upwardly, downwardly and/or otherwise as appropriate) until guide information about the desired subsequent channel is shown in the guide window. The receiver then tunes the selected channel as appropriate. In other embodiments, the channel programming itself scrolls to the programming on another channel, thereby bypassing the electronic program guide as desired.

Although the various techniques and systems described herein may be used with any sort of remote control or command equipment, various embodiments may be particularly well suited for use with a remote control that includes a touchpad, scrollbar, rocker switch, scroll ring and/or other touch-sensitive input device. A smooth-scrolling interface can be very comfortable to the viewer in such cases due to the precision and level of control provided by touch sensitive devices. While some embodiments may attempt to scroll the entire screen presentation (e.g., including the program imagery), in practice this has been difficult, particularly in satellite environments wherein rapid acquisition of multiple channel signals can be challenging. Providing a smooth-scrolling program guide window allows for a pleasing interface to the viewer that can be readily implemented using conventional hardware and software techniques.

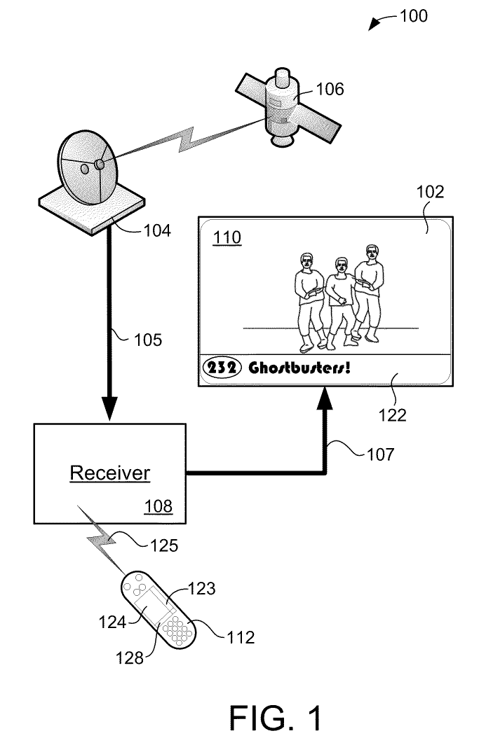

Turning now to the drawing figures and with initial reference to FIG. 1, an exemplary system 100 for presenting television signals to a viewer suitably includes a receiver 108 that receives signals 105 in any format and generates appropriate outputs 107 to generate imagery 110 on display 102. Typically, receiver 108 interacts with signals 125 received from a wireless remote control 112 to present television imagery 110 on display 102 as desired by the viewer. In the exemplary view shown in FIG. 1, imagery 110 has a superimposed program guide window 122 that provides electronic program guide (EPG) information about the currently-viewed program. To change the channel, a viewer typically uses an input feature (e.g., a touchpad, rocker switch or the like) on a remote control 112 to scroll the information displayed in window 122 until information about the desired program is presented. Receiver 108 then tunes the selected program as desired.

Receiver 108 is any component, device or logic capable of receiving and decoding video signals 105. In various embodiments, receiver 108 is a set-top box (STB) or the like capable of receiving satellite, cable, broadcast and/or other signals encoding audio/visual content. Receiver 108 may further demodulate or otherwise decode the received signals 105 to extract programming that can be locally viewed on display 102 as desired. Receiver 108 may also include a content database stored on a hard disk drive, memory, or other storage medium to support a digital or other personal video recorder (DVR/PVR) feature as appropriate. Receiver 108 may also provide place shifting, electronic program guide, multi-stream viewing and/or other features as appropriate.

In the exemplary embodiment illustrated in FIG. 1, receiver 108 is shown receiving digital broadcast satellite (DBS) signals 105 from a satellite 106 at an antenna 104. Equivalent embodiments, however, could receive programming 105 from one or more programming sources, including any sort of satellite, cable or broadcast source, as well as any Internet or other network source or the like. In embodiments that include DVR functionality, programming may be stored in any sort of database as desired (e.g., in response to user/viewer programming instructions) for subsequent viewing. Content may also be received from digital versatile disks (DVDs) or other removable media in some embodiments.

Display 102 is any device capable of presenting imagery to a viewer. In various embodiments, display 102 is a conventional television set, such as any sort of television operating in accordance with any digital or analog protocols, standards or other formats. Display 102 may be a conventional NTSC or PAL television receiver, for example. In other embodiments, display 102 is a monitor or other device that may not include built-in receiver functionality, but that is nevertheless capable of presenting imagery in response to signal 107 received from receiver 108. In various embodiments, receiver 108 and display 102 may be physically combined or interconnected in any manner. A receiver card, for example, could be inserted into a slot or other interface in a conventional television, or the functionality of receiver 108 may be provided within a conventional television display 102. In other embodiments, signals 107 are transferred between receiver 108 and display 102 using any sort of cable or other interface (including a wireless interface). Examples of common interfaces include, without limitation, component video, S-video, High-Definition Multimedia Interface (HDMI), Digital Visual Interface (DVI), IEEE 1394, and/or any other formats as desired.

Remote control 112 is any sort of control device capable providing signals 125 to receiver 108 that represent inputs received from one or more viewers. Typically, remote control 112 is an infrared, radio frequency (RF) or other wireless remote that includes any number of buttons or other features for receiving viewer inputs. In an exemplary embodiment, remote control 112 communicates with receiver 108 using the IEEE 802.15.4 (“ZIGBEE”) protocol, the RF for consumer electronics (e.g., “RF4CE” or “EC Net”) protocols, and/or any other standard or non-standard technique for implementing wireless personal area networks (WPANs). Other embodiments may instead communicate using IEEE 802.15.1 (“BLUETOOTH”), IEEE 802.11 (“WI-FI”), conventional infrared, and/or any other wireless techniques. Further, various embodiments of remote control 112 may support multiple communications schemes such both as RF and infrared, or the like.

Remote control 112 generally includes any sort of buttons, sliders, rocker switches and/or other features for receiving physical inputs from the viewer. As the user depresses or otherwise interacts with the features, remote control 112 suitably produces wireless signals 125 in response. In further embodiments, remote control 112 includes a two-dimensional input device 124 that is able to receive inputs from the user in any multi-dimensional format (e.g., “X,Y”, “r,Θ”, and/or the like). Examples of two-dimensional input devices 124 that could be used in various embodiments include, without limitation, touchpads, directional pads, joysticks, trackballs, sets of arrows or other buttons, and/or the like. In a typical implementation, two-dimensional input device 124 provides coordinates or other signals 125 that indicate absolute (e.g., “X,Y”) and/or relative (e.g., “ΔX, ΔY”) movement in two or more dimensions. Such signals 125 may be decoded at controller 108 or elsewhere to coordinate the viewer's actions with respect to input device 124 to movement of cursor 114 or other features presented on display 102.

In the exemplary embodiment shown in FIG. 1, remote control 112 is illustrated with a touchpad-type device 124 that accepts viewer inputs applied with a finger, stylus or other object. FIG. 1 also shows touchpad device 124 as having dedicated scroll regions 123 and 128 for vertical and horizontal scrolling, respectively. Viewer movements within region 123 that are more-or-less parallel to the right edge of device 124, for example, could result in vertical scrolling, whereas movements within region 128 that are more-or-less parallel to the bottom edge of device 124 could result in horizontal scrolling. Dedicated scrolling regions 123, 128 are optional features, however, that may not be present in all embodiments. Further, scrolling could be implemented in any other manner. As noted above, it may be particularly beneficial to provide a smooth scrolling image to the viewer in response to inputs received on a touch sensitive device 124, although other features may benefit from improved scrolling as well.

In operation, then, receiver 108 suitably receives television signals 105 from a satellite, cable, broadcast or other source. In a satellite based embodiment, for example, one or more channels can be extracted from a conventional satellite feed; the video content on the selected channel can be demodulated, extracted and otherwise processed as appropriate to display the desired content to the viewer. One or more cable or broadcast channels may be similarly obtained in any manner. In some embodiments, receiver 108 may obtain multiple channel signals from different sources (e.g., one channel from a cable or satellite source and another channel from a terrestrial broadcast, DVD or other source).

Receiver 108 suitably obtains the desired content from the channel(s) indicated by the viewer, and presents the content on display 102. In various embodiments, channel changing is facilitates by presenting program guide window 122 superimposed upon (e.g., presented in a smaller window within) the imagery 110 obtained from the primary channel. Other embodiments may simply scroll imagery 110 directly from channel-to-channel.

The viewer is able to interact with imagery 110 and/or program guide window 122 in any manner. In various embodiments, the viewer is able to scroll the imagery 110 and/or the information contained within window 122 using remote control 112. The scrolling provided may be relatively smooth (e.g., providing a gradual progression of information across the window 122, as opposed to simply jumping through program guide entries) so that the viewer is able to better appreciate the “feel” and level of control provided by a scrolling input on remote 112. In some embodiments, program guide window 122 could be presented with a scroll bar or other feature that would graphically represent the location of the information presented in window 122 within the overall program guide. Other embodiments may contain additional features or enhancements of any sort.

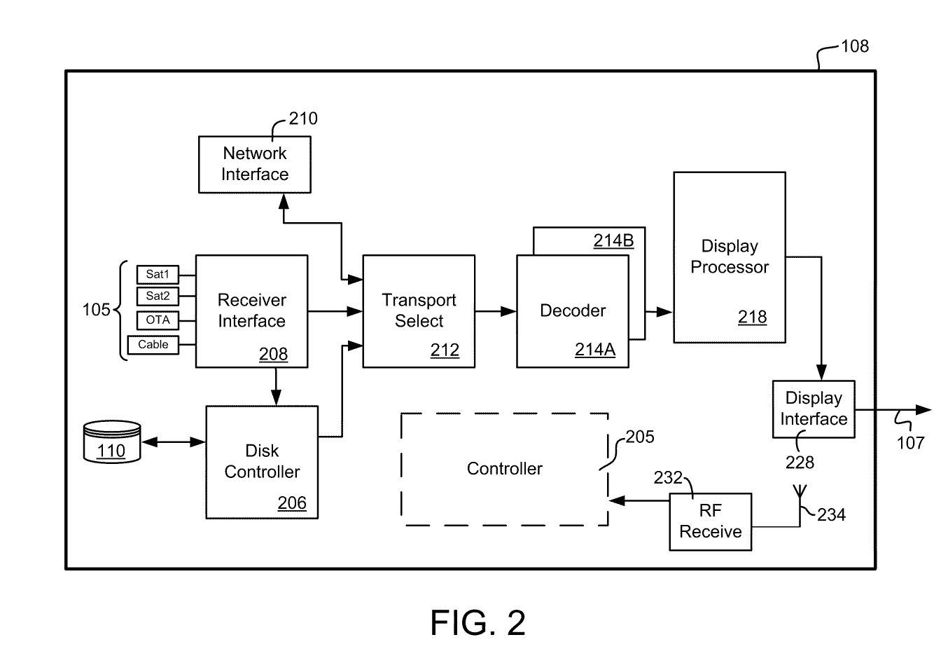

FIG. 2 provides additional detail about an exemplary receiver 108 that includes a receiver interface 208, a decoder 214 and a display processor 218, as appropriate. FIG. 2 also shows a disk controller interface 206 to a disk or other storage device 110, an interface 210 to a local or wide area network, a transport select module 212, a display interface 228, an RF receiver module and control logic 205. Other embodiments may incorporate additional or alternate processing modules from those shown in FIG. 2, may omit one or more modules shown in FIG. 2, and/or may differently organize the various modules in any other manner different from the exemplary arrangement shown in FIG. 2.

Receiver 108 may be physically and logically implemented in any manner. FIG. 2 shows various logical and functional features that may be present in an exemplary device; each module shown in the figure may be implemented with any sort of hardware, software, firmware and/or the like. Any of the various modules may be implemented with any sort of general or special purpose integrated circuitry, for example, such as any sort of microprocessor, microcontroller, digital signal processor, programmed array and/or the like. Any number of the modules shown in FIG. 2, for example, may be implemented as a “system on a chip” (SoC) using any suitable processing circuitry under control of any appropriate control logic 205. In various embodiments, control logic 205 executes within an integrated SoC or other processor that implements receiver interface 208, transport selector 212, decoder 214, display processor 218, disk controller 206 and/or other features, as appropriate. The Broadcom Corporation of Irvine, Calif., for example, produces several models of processors (e.g., the model BCM 7400 family of processors) that are capable of supporting SoC implementations of satellite and/or cable receiver systems, although products from any number of other suppliers could be equivalently used. In still other embodiments, various distinct chips, circuits or components may be inter-connected and inter-relate with each other to implement the receiving and decoding functions represented in FIG. 2.

Various embodiments of receiver 108 therefore include any number of appropriate modules for obtaining and processing media content as desired for the particular embodiment. Each of these modules may be implemented in any combination of hardware and/or software using logic executed within any number of semiconductor chips or other processing logic.

Various embodiments of control logic 205 can include any circuitry, components, hardware, software and/or firmware logic capable of controlling the various components of receiver 108. Various routines, methods and processes executed within receiver 108 are typically carried out under control of control logic 205, as described more fully below. Generally speaking, control logic 205 receives user input signals 125 (FIG. 1) via an RF receiver interface 232 that is able to communicate with the remote control 112 using a suitable antenna 234. Control logic receives user inputs from remote control 112 and/or any other source, and directs the other components of receiver 1o8 in response to the received inputs to present the desired imagery on display 102.

As noted above, receiver 108 suitably includes a receiver interface 208, which is any hardware, software, firmware and/or other logic capable of receiving media content via one or more content sources 105. In various embodiments, content sources 105 may include cable television, DBS, broadcast and/or other programming sources as appropriate. Receiver interface 208 appropriately selects a desired input source and provides the received content to an appropriate destination for further processing. In various embodiments, received programming may be provided in real-time (or near real-time) to a transport stream select module 212 or other component for immediate decoding and presentation to the user. Alternatively, receiver interface 208 may provide content received from any source to a disk or other storage medium in embodiments that provide DVR functionality. In such embodiments, receiver 108 may also include a disk controller module 206 that interacts with an internal or external hard disk, memory and/or other device that stores content in a database 110, as described above.

In the embodiment shown in FIG. 2, receiver 108 also includes an appropriate network interface 210, which operates using any implementation of protocols or other features to support communication by receiver 108 on any sort of local area, wide area, telephone and/or other network. In various embodiments, network interface 210 supports conventional LAN, WAN or other protocols (e.g., the TCP/IP or UDP/IP suite of protocols widely used on the Internet) to allow receiver 108 to communicate on the Internet or any other network as desired. Network interface 210 typically interfaces with the network using any sort of LAN adapter hardware, such as a conventional network interface card (NIC) or the like provided within receiver 108. Other embodiments may provide interfaces 210 to conventional telephone lines or other communications channels, or may omit network connectivity altogether.

Transport stream select module 212 is any hardware and/or software logic capable of selecting a desired media stream from the available sources. In the embodiment shown in FIG. 2, stream select module 212 is able to generate video signals for presentation on one or more output interfaces 228. Typically, transport select module 212 responds to viewer inputs (e.g., via control logic 205) to simply switch encoded content received from a broadcast, satellite, cable or other source 105 or from storage 110 to one or more decoder modules 214.

Receiver 108 may include any number of decoder modules 214A-B for decoding, decompressing and/or otherwise processing received/stored content as desired. Generally speaking, decoder modules 214A-B decompress, decode and/or otherwise process received content from transport select module 212 to extract an MPEG or other media stream encoded within the stream. The decoded content can then be processed by one or more display processor modules 218 to create a presentation on display 102 (FIG. 1) for the viewer in any appropriate format. FIG. 2 shows two decoder modules 214 operating on television signals received from transport select module 212. In practice, any number of decoder modules 214 may be used, particularly in PIP settings where multiple signals are simultaneously decoded and displayed, or in embodiments wherein channel content is directly scrolled across other channel content. In such embodiments, it may be desirable to receive multiple channels simultaneously to facilitate the rapid scrolling of content on a common display of imagery 110. That is, by simultaneously tuning and decoding content from multiple channels, the scrolling from one channel to the next can be facilitated. Other embodiments, however, may not make use of multiple decoder modules 214, but may instead only decode a single stream at any particular time. The term “decoder”, then, may collectively apply to one or more decoder modules that are able to decode one or more signals for presentation on display 104.

Display processor module 218 includes any appropriate hardware, software and/or other logic to create desired screen displays via display interface 228 as desired. Such displays may include combining signals received from one or more decoder modules 214 to facilitate viewing of one or more channels. In various embodiments, display processing module 218 is also able to produce on screen displays (OSDs) for electronic program guide, setup and control, input/output facilitation and/or other features that may vary from embodiment to embodiment. Such displays are not typically contained within the received or stored broadcast stream, but are nevertheless useful to users in interacting with receiver 108 or the like. The generated displays, including received/stored content and any other displays may then be presented to one or more output interfaces 228 in any desired format. The various interface features described herein, for example, may be generated by display processor module 218 operating alone or in conjunction with control logic 205.

When the viewer requests channel change, for example, display processor 218 may be operable to superimpose program guide window 122 (FIG. 1) over the imagery 110 presented from the primary channel. Display processor 218 may also generate symbology to scroll the program guide information presented in window 122 in response to viewer inputs received and/or instructions from command logic 205 to thereby make up a user interface that allows the viewer to adjust window 122 (or other features) as desired. As receiver 108 receives user inputs 125 from remote control 112, control logic 205 may direct display processor 218 to adjust window 122 or any other feature of imagery 110 as directed by the viewer. Display processor 218 therefore directs the presentation of program guide window 122 in conjunction with one or more navigation features, and adjusts the program guide window 122 in response to inputs received from the viewer. As noted above, other embodiments may simply scroll the content of one channel over that of another, thereby creating a direct scrolling of channel data without the need for program guide window 122.

Display processor 218 produces an output signal encoded in any standard format (e.g., ITU656 format for standard definition television signals or any format for high definition television signals) that can be readily converted to standard and/or high definition television signals at interface 228. In other embodiments, the functionality of display processor 218 and interface 228 may be combined in any manner.

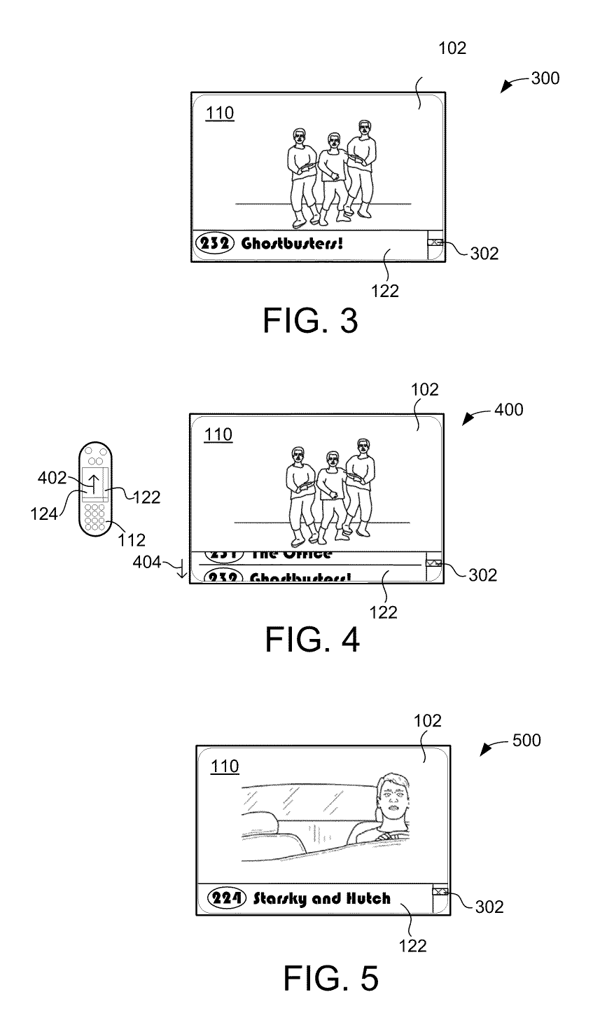

FIGS. 3-5 show an exemplary progression of displays 300, 400, 500 that would allow a viewer to change a channel from a showing of the “Ghostbusters!” movie on channel 232 to a showing of the “Starsky and Hutch” program on channel 224 using a program guide window 122. Of course the various parameters shown in these figures is purely exemplary; in practice, any number of scrolling techniques may be applied in any manner to allow any appropriate action by the viewer.

Beginning with FIG. 3, an exemplary display 300 suitably includes a program guide window 122 superimposed upon primary imagery 110, as described above. Program guide window may be initially presented in response to any suitable conditions; a button press or application of input to a directional input feature 124 on remote control 112, for example, could result in the program guide window 112 being automatically displayed.

Program guide window 122 provides any appropriate information about programs available to the viewer. In the exemplary embodiment shown in FIGS. 1-5, program guide window 122 provides a channel number and the name of the program being shown on that channel. Other embodiments may alternately or additional provide network or channel identification (e.g., “Fox 15”, “KSAZ”, “HBO” and/or the like), program times, content descriptions, parental control ratings, and/or any other information as desired. Such information is conventionally provided to receiver 108 using any sort of electronic programming guide techniques; the information may be readily retrieved from the guide and displayed in any manner.

Although the embodiment shown in FIG. 3 only shows a single line of program guide information, other embodiments may display multiple lines as desired. The other lines shown may correspond to programs showing on other channels (e.g., channels that adjoin the currently viewed channel). In such embodiments, the currently tuned channel may be highlighted or otherwise emphasized in any manner to allow for ready identification of the current and most relevant information.

The exemplary embodiment shown in FIGS. 3-5 includes a scroll indicator 302 that indicates the relative position of the information presented in window 122 with respect to the available guide data. Scroll indicator 302 may move upwardly or downwardly (as presented in FIGS. 3-5) as the viewer scrolls through the information presented in program guide window 122 to further increase the awareness of the viewer. Scroll indicator 302 may be differently shaped, positioned or otherwise implemented in any manner, or may be omitted entirely in some embodiments.

To allow the viewer to change from the initial channel (e.g., channel 232) to a desired channel (e.g., channel 224), receiver 104 suitably responds to scrolling instructions applied by the viewer at remote 112. In various embodiments, the list of available channels may be conceptualized as a sequential list. Scrolling upwardly or downwardly through the list, then, can be accomplished in response to any sort of input having one or more dimensions. In a simple embodiment, a rocker switch, scroll ring, scroll bar or other one dimensional input can be used to direct scrolling in either direction (e.g., upward or downward, as shown in FIGS. 3-5). In other embodiments, inputs from a two-dimensional input device (e.g., a touchpad, joystick, directional pad or other 2-d device 124) can be readily converted to a one-dimensional input by simply ignoring movement in one dimension. Vertical movement on a touchpad 124, for example, can be readily extracted by simply ignoring movement in the horizontal direction. In an exemplary embodiment, scrolling inputs are provided by the viewer by applying finger pressure to a touchpad 124, or to a scroll region (e.g., region 123) associated with touchpad 124. Other embodiments may provide a separate one-dimensional scroll region similar to region 123. Still other embodiments may provide scrolling commands based upon inputs received at entirely different interface features such as buttons, sliders, motion sensors and/or the like.

With reference to FIG. 4, inputs applied at remote control 112 may be correlated to scrolling in window 122 in any manner that is intuitive or understandable to the viewer. In an exemplary embodiment, movement in an “upward” direction 402 on remote 112 can result in scrolling in a downward direction (e.g., represented by arrow 404 in FIG. 4). The downward movement (e.g., text progresses from the top of window 122 toward the bottom of window 122) gives the appearance that the frame of reference (e.g., window 122) is actually moving upward. Hence, downward scrolling in response to “upward” movement 402 appears natural to the viewer.

Scrolling proceeds in any appropriate manner. In various embodiments, scrolling is relatively smooth in that information appears to the viewer to smoothly proceed from one edge of window 122 to the opposing edge of the window. FIG. 4, for example, shows scrolling that is midway between the current channel (channel 232) and the next channel in the indicated direction (channel 231). In many embodiments, the contents of window 122 appear as a continuous scroll of text and/or other information so that the smooth feel of the input device 112 can be preserved. Such scrolling may be line-by-line, pixel-by-pixel, or according to any other scheme that allows for a pleasing appearance and feel to the viewer. Note that in example shown in FIG. 4, the contents of window 122 are shown approximately midway between two channels, reflecting that the scrolling is continuous from one channel to the next, rather than a mere sequential presentation of data from one channel to the next. In various embodiments, the program guide information shown in window 122 may be re-aligned to “snap” to the closest channel if scrolling should stop while the information is midway between two channel descriptions.

When the viewer has scrolled to the desired channel, receiver 104 tunes to the selected program. FIG. 5, for example, shows that display 110 has been changed from the program on channel 232 to the program on channel 224. The selected program may be indicated in any manner; the viewer may depress a “select” key or other feature on remote control 112, for example. Alternately, if scrolling inputs are discontinued for a threshold period of time, the channel indicated in the program guide window 122 may be tuned without waiting for additional input. That is, the viewer simply scrolls to the desired program, and then stops scrolling to allow the receiver 104 to tune the selected program. Other embodiments may modify or supplement this scheme in any manner.

As noted above, alternate embodiments may simply scroll imagery 110 from channel to channel directly. This may be accomplished, for example, by tuning the current channel in addition to one or more channels adjacent to the current channel. As the viewer provides a directional movement (e.g., an upward or downward indication) on remote control 112, the imagery 110 on display 102 is scrolled in a corresponding direction. This tuning and scrolling of channel content can continue until the viewer has scrolled to the desired channel.

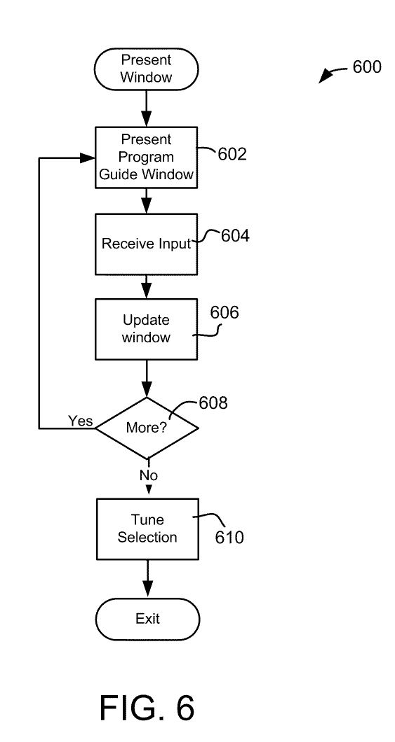

FIG. 6 shows an exemplary process 600 for changing imagery presented on a display 102 using a program guide window 122. In various embodiments, the various steps shown in FIG. 6 may be executed using source or object code in any format that may be stored in mass storage, firmware, memory or any other digital storage medium within receiver 104. Such code may be executed by any module or combination of modules operating within receiver 104. In an exemplary embodiment, some or all of the steps shown in process 600 are executed by a display processing module 218 (FIG. 2) operating alone or in conjunction with control logic 205 and/or the various other features shown in FIG. 2 and described above.

With reference now to FIG. 6, an exemplary process 600 suitably includes the broad steps of presenting a program guide window (step 602), receiving viewer input from the remote control 112 (step 604), updating the program guide window (step 606) to accommodate scrolling or other features as desired, and then tuning to the selected channel or other feature (step 610). Other embodiments may supplement or modify these basic steps in any manner; various steps may execute in any other temporal manner, for example.

Program guide window 122 may be drawn in any manner (step 602). In various embodiments, window 122 is drawn in response to initial input received from the viewer, such as an initial touch at a touchpad, slider or other device 124. This initial presentation typically includes information about the current channel, as described above. Presentation of the program guide window may be directed by display processor 218, as described above, in response to signals 125 received by receiver module 232, or as otherwise directed by control logic 205. Other embodiments, however, may generate and provide the program guide window 122 in any other manner.

Viewer input can also be used to direct scrolling of program guide data, as described above. As viewer inputs are received (step 604), this information can be used to direct scrolling toward subsequent program guide information. Scrolling can proceed in either of two directions, for example, to present information from channels that appear above or below the initially-selected channel in the channel list. The program guide window 122 is therefore updated (step 606) to reflect the continued scrolling inputs, and/or to accommodate other inputs as desired. As noted above, the scrolling may be generally smooth in the sense of text or other imagery progressing from one side of window 122 to the opposing side, then disappearing from view. This presents a very pleasing perception to the user that corresponds well to touch or other scrolling inputs received at remote control 112. Updates to window 122 may be provided by redrawing or refreshing the presentation of window 112 on display 102 at any frequency.

As noted above, scrolling may continue on any temporal basis. In various embodiments, scrolling remains active until the viewer selects a particular channel for subsequent viewing. In other embodiments, scrolling remains active until viewer input is discontinued (step 6o8). That is, scrolling continues until appropriate input signals 125 are no longer received, at which time the channel indicated in window 122 can be tuned (step 610), or other actions can be taken as desired.

The viewer's selection can be tuned in any manner (step 610). In various embodiments, a subsequent channel indicated by the program guide information in window 122 can be tuned (e.g., by decoder 214) to present the selected channel to the viewer as imagery 110.

Accordingly, new systems and techniques for graphically changing a channel or other feature are described. Although the systems and features are generally described herein as applying to changing a channel, equivalent embodiments could apply the same concepts to scrolling and selection of program guide features, menu items, parameter selection, selection of programs stored on a DVR, selection of programs from a network host or other source, selection of programs for placeshifting, and/or any other features as desired.

As used herein, the word “exemplary” means “serving as an example, instance, or illustration.” Any implementation described herein as exemplary is not necessarily to be construed as preferred or advantageous over other implementations.

While the foregoing detailed description will provide those skilled in the art with a convenient road map for implementing various embodiments of the invention, it should be appreciated that the particular embodiments described above are only examples, and are not intended to limit the scope, applicability, or configuration of the invention in any way. To the contrary, various changes may be made in the function and arrangement of elements described without departing from the scope of the invention.

What is claimed is:

1. A method for changing the presentation of a current channel to another channel on a display in response to a viewer input received via a remote control, the method comprising:
presenting imagery on the display;
receiving the viewer input from the remote control; and
scrolling at least a portion of the imagery in response to the viewer input to thereby tune the other channel on the display.

2. The method of claim 1 wherein the viewer input comprises a directional input.

3. The method of claim 1 wherein the scrolling is in a direction corresponding to the directional input.

4. The method of claim 1 further comprising presenting a program guide window on the display, wherein the program guide window initially comprises program guide information corresponding to the current channel.

5. The method of claim 4 wherein the scrolling comprises scrolling the program guide information in the program guide window in response to the viewer input from the information corresponding to the current channel to information about the other channel.

6. The method of claim 5 further comprising tuning the other channel indicated by the displayed program guide information.

7. The method of claim 5 wherein the scrolling comprises a line-by-line progression of the program guide information.

8. The method of claim 5 wherein the scrolling comprises a gradual progression of the program guide information while the viewer input continues.

9. The method of claim 8 further comprising re-aligning the program guide information to the program guide window when the viewer input is discontinued.

10. The method of claim 8 further comprising relating an amount of scrolling of the program guide information to an amount of viewer input.

11. The method of claim 10 wherein the amount of scrolling increases in response to larger viewer inputs.

12. The method of claim 1 wherein the other channel is tuned in response to a select instruction received from the remote control.

13. The method of claim 1 wherein the program guide window comprises a scroll indicator that moves in a direction indicated by the viewer input.

14. The method of claim 1 wherein the scrolling comprises a gradual progression.

15. The method of claim 1 further comprising tuning the current channel to obtain first channel imagery and also tuning a second channel adjacent to the current channel to obtain second channel imagery.

16. The method of claim 15 wherein the scrolling comprises scrolling the second imagery over the first imagery.

17. The method of claim 16 further comprising repeating the tuning and scrolling until the second imagery corresponds to the other channel.

18. A video receiver for presenting imagery on a display in response to viewer input signals provided from a remote control, the receiver comprising:
a receiver interface configured to receive an incoming modulated signal;
a decoder configured to decode the incoming modulated signal to extract a video signal;
a wireless receiver configured to receive the viewer input signals from the remote control; and
a processor configured to generate the imagery presented on the display, wherein the imagery comprises the extracted video signal, and wherein the processor is further configured to change a channel associated with the video signal to a desired channel in response to the viewer input signals by generating a program guide window on the display that initially comprises program guide information corresponding to a current channel, and wherein the program guide information scrolls in the program guide window in response to the viewer input to display other program guide information until the desired channel is indicated by the displayed subsequent program guide information.

19. The video receiver of claim 18 wherein the receiver interface comprises a satellite interface.

20. The video receiver of claim 18 wherein the receiver interface comprises a cable interface.

21. The video receiver of claim 18 wherein the wireless receiver is configured to receive the two-dimensional input signal from a wireless remote control comprising a two-dimensional input device.

22. The video receiver of claim 21 wherein the two-dimensional input device is one of the group consisting of: a touchpad, a trackball, a joystick, and a directional pad.

23. The video receiver of claim 18 wherein the processor is further configured to gradually scroll the program guide information while the viewer input continues.

24. The video receiver of claim 23 wherein the processor is further configured to re-align the program guide information to the program guide window when the viewer input is discontinued.

25. The video receiver of claim 18 further comprising relating an amount of scrolling of the program guide information to an amount of viewer input such that the amount of scrolling increases in response to larger viewer inputs.

26. A system for presenting television content on a display, the system comprising:
a wireless remote control configured to provide an input signal in response to a user input; and
a video receiver comprising:
a receiver interface configured to receive an incoming modulated signal;
a decoder configured to decode the incoming modulated signal to extract a television content;
a wireless receiver configured to receive the two-dimensional input signal from the wireless remote control; and
a processor configured to generate imagery to be presented on the display, wherein the imagery comprises the extracted television content, and wherein the processor is further configured to allow the viewer to change a channel associated with the television content to a desired channel in response by generating a program guide window that initially comprises program guide information corresponding to a current channel, and wherein the program guide information gradually scrolls in the program guide window in response to the viewer input to display other program guide information until the desired channel is indicated by the displayed subsequent program guide information.
